(19) United States
(12) Patent Application Publication
(10) Pub. No.: US 2018/0289027 A1
(43) Pub. Date: Oct. 11, 2018

(54) PACKAGED AMBIENT DAIRY BEVERAGE WITH REDUCED MILK SOLIDS

(71) Applicant: NESTEC S.A., Vevey (CH)

(72) Inventors: Virginie Kapchie, Dublin, OH (US); Ying Zheng, Dublin, OH (US); Philippe Rousset, Dublin, OH (US); Alexander Sher, Dublin, OH (US); Soad Balla, Lewis Center, OH (US)

(21) Appl. No.: 15/766,579

(22) PCT Filed: Oct. 6, 2016
(86) PCT No.: PCT/EP2016/073900

§ 371 Date: Apr. 6, 2018

Related U.S. Application Data
(60) Provisional application No. 62/240,410, filed on Oct. 12, 2015.

(51) Int. Cl. A23C 9/152; A23C 9/154; A23C 9/156

(52) U.S. Cl. CPC A23C 9/1522; A23C 9/1524; A23C 9/1528; A23V 2250/18; A23C 9/156; A23V 2002/00; A23C 9/154

(57) ABSTRACT

A dairy beverage comprising milk solids, oil or fat, starch, emulsifier, gellan, cellulose and carrageenan in specific amounts in a closed container is disclosed. The beverage may be foamed by shaking, to provide a pleasant aerated texture/mouthfeel.

### TECHNICAL FIELD

The invention relates to a packaged dairy beverage, specifically an ambient dairy beverage which exhibits stable, creamy, and aerated texture upon shaking by hand.

### BACKGROUND OF THE INVENTION

Milk-based beverages are popular drinks amongst the consumers, because they are viewed as healthier alternatives to sparkling sodas, with nutritious properties. Certain of these milk-based beverages with an aerated indulgent texture after shaking create a delight among consumers. Such foamy beverages are perceived to have a creamy and indulgent texture. However, this depends strongly on the foam properties, such as bubble size and distribution, origin of the bubbles, for instance by gasification with carbonic gas, or by fermentation with yeasts which generate carbonic gas.

It is also desirable to have aseptic shelf-life stable product with improved product aerated foamy mouthfeel and shelf-life stability.

Over the recent years, the applicants have filed several patent applications relating to ready-to-drink dairy-based beverage which are shelf-stable at ambient temperatures, for instance during 6 months at temperatures ranging from 15° C. to 30° C. In order to avoid biological spoilage, such beverages undergo heat treatments which have a strong impact on stability, and may provoke gelation, syneresis and other undesirable physical evolution over shelf life. Specific stabiliser systems have been developed in order to avoid or mitigate such physical evolution. These beverages under the protection did not deliver any foamy functionality.

Experience shows that usually, the stabiliser systems used to reach a required shelf-life after a specific heat-treatment depends on the recipe of the ready-to-drink dairy-based beverage, such as macronutrient content (e.g. protein, carbohydrate, lipids), total solids, pH, or micronutrient content (vitamins and minerals in particular).

The inventors have found that there exist several coffee-flavoured milk beverages. However, these beverages have either a very watery mouthfeel or top foam such as Café Deli. The applicant recently launched products which are examples of packaged dairy beverage made up of milk-rich coffee. These products were designed to be consumed straight from the fridge or chiller cabinet, in other words, this beverage is not an ambient beverage as described for the purpose of present invention. This product is a chilled dairy product with a good aeration upon shaking by hand. However, it has a short shelf-life of about 70 days at chilled temperatures. Moreover, it cannot be stored at ambient temperatures. There are several shortcomings to this, including the need to maintain the cold distribution chain at all times, including during transportation and storage. It cannot be stored at ambient temperatures.

US 2007/0178213 A1 relates to a stirred-style aerated yogurt which can be consumed as a flowable beverage. An aerating gas, nitrogen, is integrated in the product. U.S. Pat. No. 4,374,155 relates to a drinkable yogurt and milk preparation.

The inventors have found it desirable to overcome or ameliorate at least one of the disadvantages of the prior art, or to provide a useful alternative. In particular, the inventors have set themselves to create a dairy-based product which is shelf-stable under ambient conditions and which can provide a pleasant foamy beverage upon shaking.

### SUMMARY OF THE INVENTION

In one aspect, the present invention relates to an aseptic dairy beverage in a closed container having a headspace of 18 to 35 vol. % of the volume of the container, wherein said beverage comprises: reduced milk solids ranging from 2 to 6 wt % of; added oil or fat ranging from 1 to 3 wt %; starch ranging from 1 to 3 wt %; emulsifier ranging from 0.05 to 0.15 wt %; gellan ranging from 0.01 to 0.04 wt %; cellulose ranging from 0.4 to 0.6 wt %; and carrageenan ranging from 0.00 to 0.06 wt %; and wherein said beverage has a pH ranging from 6.2 to 6.9. The advantage of the beverage of the invention is that the novel combination of ingredients results in a final beverage which exhibits good physical stability during extended shelf-life of the product, and aeration after shaking the product. The aerated product has integrated, stable gas bubbles distributed throughout the beverage such that the consumer can taste a frothy indulgent mouthfeel.

In one aspect of the present invention, the beverage further comprises coffee ranging from 0.9 to 1.5 wt %.

In another aspect, the invention proposes a process for preparing a foamy aseptic dairy beverage which comprises the step of 1) providing a packaged product comprising the beverage of the present invention, wherein said packaged product is optionally refrigerated, then 2) shaking said packaged product to obtain said foamy dairy beverage.

In a third embodiment, the invention proposes the use of a packaged product according to the first embodiment of the invention, for preparing a foamy aseptic dairy beverage by shaking, wherein said packaged product consists essentially of a dairy beverage in a closed container.

### BRIEF DESCRIPTION OF THE DRAWINGS

FIG. 1 shows effect of pH on product aeration after shaking.

### DETAILED DESCRIPTION OF THE INVENTION

Unless noted otherwise, all percentages in the specification refer to weight percent (noted wt %). The term wt % represents weight/weight % of total dairy beverage.

Unless defined otherwise, all technical and scientific terms have and should be given the same meaning as commonly understood by one of ordinary skill in the art to which this invention belongs, that of aseptic dairy beverages.

Unless defined otherwise, the term “aerated” applies to the entire beverage.

The beverage is suitable for preparing a aerated beverage by shaking it in the closed container. The consumer can then open the container to drink the aerated beverage directly from it. The consumer can also pour the aerated beverage from a bottle into another container such as glass or cup, for consumption.

Unless defined otherwise, the term “aerated” applies to the entire beverage containing gas bubbles after shaking. Gas is present in the headspace of a container and can comprise but not limited to air, nitrogen, argon or a combination of thereof.

Throughout the specification, an “aseptic beverage” refers to a beverage which is processed and filled under aseptic conditions into a container. “Shelf life” refers to the period of time after production of the beverage, during which the beverage is transported, and stored in retailers' or consumers' shelves, before consumption. The aseptic beverage has a shelf life of at least 6 months at ambient temperature. “Ambient temperature” ranges from 15° C. to 38° C. Preferably, the aseptic beverage has a shelf life of at least at least 2 months at 38° C., or 6 months at 30° C., or 9 months at 20° C.

The term “milk solids” refer to milk based products derived from different sources such as skim milk, whole milk, whole or skim milk powder, and cream. Other examples of suitable milk solids are casein, caseinate, casein hydrolysate, whey, whey hydrolysate, whey concentrate, whey isolate, milk protein concentrate, milk protein isolate, and combinations thereof Furthermore, the milk protein may be, for example, sweet whey, acid whey, α-lactalbumin, β-lactoglobulin, bovine serum albumin, acid casein, caseinates, α-casein, β-casein and/or γ-casein. In a preferred embodiment, the beverage does not contain dairy substitute ingredients.

In an embodiment, the beverage comprises from 2 to 6 wt % of milk solids, preferably from 2 to 3.9 wt % of milk solids, and more preferably from 2 to 3 wt % of milk solids, such as 2 wt %, 2.5 wt %, 2.8 wt %, 3.5 wt %, or 3.9 wt % of milk solids. Milk proteins from the milk solids have an impact on foamability and foam stability.

The term “oil or fat” refers to compounds having melting point above 25° C. Certain examples include palm olein oil, coconut oil, milk fat or combinations thereof.

In an embodiment, the beverage comprises about or less than 3 wt % of fat, such as milk fat from 0.5 to 3 wt % of fat, preferably from 0.8 to 2.9wt % of milk fat, such as 1 wt %, 1.5 wt %, 2.5 wt %, or 2.9 wt % of milk fat.

The term “emulsifier” includes monoglycerides and derivatives, diglycerides derivatives, lecithin (for example soy or sunflower lecithin), diacetyl tartaric acid esters of mono-diglycerides, emulsifying starches and mixtures thereof. In one embodiment, the emulsifier has a hydrophobic-lipophilic balance (HLB) value ranging from 6 to 11. The advantage of using emulsifiers with particular HLB values is that they impart good physical properties when added to the beverage of the present invention. These properties include good shelf-life stability and aeration property after shaking the beverage.

In another embodiment, the emulsifier is diacetyl tartaric acid esters of mono-diglycerides having HLB value of 6.

In one embodiment, the carrageenan comprises iota, kappa, lambda or combinations thereof.

In one embodiment, the starch comprises starches such as modified hydroxypropyl starch.

The sweetener component comprises a sweetener, such as sugar (sucrose) or a non-caloric sweetener. For instance, the beverage comprises from 0.5 to 6 wt % of sugar. “Added sugar” refers to caloric mono- and di-saccharides added during manufacture of the beverage, such as glucose, sucrose, maltose, fructose, or combination of thereof, which are not naturally found in the dairy component. For instance, lactose is naturally found in milk, therefore, for the purpose of this disclosure, lactose is not taken into account in “added sugar”.

The flavour component provides flavour to the beverage, in addition to the milk flavour which comes from the dairy component. The flavour component comprises a flavour ingredient selected from coffee, cocoa, tea, caramel, vanilla, cinnamon, cardamom, saffron, clove, strawberry, banana and mixtures thereof. In a preferred embodiment, the beverage comprises a coffee component. Coffee component may be provided as liquid or viscous coffee concentrate, or as instant powdered coffee, such as spray-dried powdered coffee or freeze-dried powdered coffee, roast and ground coffee, coffee flavour or combination of thereof. Preferably, the beverage comprises from 0.9 to 1.5 wt % of coffee component, such as soluble powdered coffee.

In an embodiment of the present invention, the dairy based beverage further comprises nut based components such as peanuts, almond, hazelnut, and cashew.

The texturizing/stabilizing component provides mouthfeel and viscosity, contributes to shelf-stability of the product at refrigeration and ambient temperatures, and helps maintaining the foamy texture of the beverage after shaking. The component comprises cellulose and gellan in specific concentrations. More specifically, the beverage comprises from 0.4 to 0.6 wt % of cellulose, and from 0.01 to 0.04 wt % of gellan. In one embodiment the cellulose comprises a blend of carboxymethyl cellulose and microcrystalline cellulose.

In another embodiment, the gellan is high-acyl gellan.

In an embodiment, the beverage further comprises buffering agent. The buffering agent can be, for example, monophosphates, diphosphates, sodium mono- and bicarbonates, potassium mono- and bicarbonates or a combination thereof More specifically, non-limiting examples of suitable buffers are salts such as potassium phosphate, potassium phosphate, potassium bicarbonate, potassium citrate, sodium bicarbonate, sodium citrate, sodium phosphate, disodium phosphate. Preferably, the buffering agent represents from about 0.03 to about 0.1% of the total weight of the product.

In an embodiment, the aseptic dairy beverage contains from 14 to 25 wt % of total solids, preferably from 18 to 20 wt % total solids. The total solids content is involved in the overall mouthfeel and viscosity of the beverage.

The aseptic dairy beverage is manufactured by providing a standardised liquid milk composition, which comprises milk solids ranging from 2 to 6 wt %. The mix composition may be prepared by mixing liquid skim milk, milk cream and skimmed milk powder. In addition, the following ingredients such as oil and emulsifiers are added to the mix. Sweetener components such as sugar, flavour components, such as a coffee component, and texturiring/stabilizing component, are also mixed into the liquid mix composition. For instance, mixing is done at about 70° C., during 30 minutes. Then, the pH of the mix is adjusted to be in range of 6.2 to 6.9. pH may be adjusted using a buffering agent, such as sodium bicarbonate and dipotassium phosphate. The mixture is then pre-heated to about 70° C. and then sterilized typically at 141-143° C. for 5 seconds. Sterilisation removes biological contamination from the mixture. Alternative heat-treatments are known to the person of ordinary skill in the art. Then the sterilised mixture is cooled to about 70° C. prior to two stage homogenisation under a typical pressure of 150/50 bar in a conventional homogeniser. Homogenisation further disperses the fat component and other ingredients. Then the beverage is cooled to refrigerated temperatures, and filled into a container, such as a cup or a bottle. Filling is done under aseptic conditions. In an embodiment, filling is performed under a controlled atmosphere, to flush oxygen out of the headspace. For instance, controlled atmosphere is a nitrogen atmosphere. The container is then sealed. When the container is a bottle, sealing can be done with a standard screw lid. When the container is a cup, sealing can be done with a standard foil seal.

Rather than ensuring that the beverage retains a foamy texture over the whole shelf life, the inventors have now provided a non-foamy beverage which can be aerated by hand shaking and deliver a pleasant frothy texture during consumption. As mentioned, the areated texture is obtained by shaking the beverage in its closed container, for instance by hand. Shaking by hand may be done by holding the container in the hand, and bending and stretching the arms several times, for instance from 3 to 15 times. Generally, about 5 to 10 movements are sufficient to generate a pleasant foamy texture in the beverage. The beverage retains pleasant aerated texture/mouthfeel at least 10 minutes after shaking of the refrigerated beverage at 4° C. The beverage also retains pleasant aerated texture/mouthfeel at least 10 minutes after shaking of the refrigerated beverage at ambient temperature of 20° C.

An advantage is that there is no concern about shelf stability of the aeration. Only the shelf stability of the beverage before shaking is a concern. In an embodiment, the beverage is shelf-stable at ambient temperatures, for instance during 6 months at temperatures ranging from 15° C. to 30° C. Relatively long shelf stability of the beverage is achieved thanks to the unique texturing/stabilizing system that includes combination of hydrocolloids and emulsifiers and aseptic manufacturing conditions, together with sterilisation, of the beverage.

An example of a container is a cup. The cup has a bottom wall, a side wall, and a lid. Shaking the beverage disperses the headspace gas such as air as bubbles into the beverage. The composition of the beverage, in particular the combination of hydrocolloids and emulsifiers, was developed so that the bubbles remain distributed in the whole volume of the beverage during consumption, and to provide a pleasant mouthfeel. The fact that the bubbles are distributed in the whole volume of the beverage provides a pleasant foamy texture. For instance, the refrigerated beverage retains a aerated texture during at least 10 minutes after shaking.

Assessment of the foamy texture is performed by a trained sensory panel, as explained in the examples below. The maximum period during which bubbles are retained in the beverage is not absolutely critical, as the main criteria is that there are bubbles in the product until the consumer has completely drunk the beverage. Ordinarily, such beverages are consumed in less than 30 minutes. Preferably, the beverage retains a foamy texture during at least 15, 20, 25, or 30 minutes.

The inventors have found that if the headspace is too small, then the closed container does not contain enough gas to provide a pleasant foamy texture upon shaking. For instance, it was found that a headspace of 15 vol. % was too low to provide a pleasant foamy texture after shaking. Therefore, the headspace represents preferably at least 18% by volume (vol. %) of the volume of the container.

On the other hand, if the headspace is too large, it may have several undesirable consequences. First, the consumer could consider that the container is not filled enough. Second, a large headspace for the same amount of the beverage can only be provided with a large container. This increases the cost of packaging and the amount of waste. Third, the inventors have found that if the headspace is too large, then the container tends to squash itself over shelf life. It was found that a good balance is achieved between these undesirable consequences, industrialisation considerations and the need to provide sufficient gas for aeration when the headspace represents up to 35 vol. % of the volume of the container.

In an embodiment, the headspace represents from 18 to 35 vol. % of the volume of the container. In other words, if the container has a volume of 100 mL, then the headspace represents from 18 mL to 35 mL, and the remainder is the beverage (65 mL to 82 mL). Preferably, the headspace represents from 20 to 32 vol. % of the volume of the container, more preferably, from 30 to 32 vol. % of the volume of the container.

In an embodiment, the height of the cup ranges from 90 to 150 mm and the volume of the cup range from 100 to 300 mL. The cup contains one serving of the beverage. For instance, one serving of beverage represents from 80 to 220 mL of beverage before shaking.

When the container is a PET bottle, it may be desirable to provide it common strengthening features, such as ribs.

In an embodiment, the bottle has a volume of 240 ml. Preferably, the bottle contains one serving of the beverage. For instance, one serving represents from about 150 to 180 mL of beverage before shaking.

In another embodiment, the invention relates to a process for preparing a aseptic dairy beverage which comprises the steps of providing a packaged product as described above, then shaking the packaged product to obtain an aerated dairy beverage. Optionally, the packaged product may be refrigerated prior to shaking, so that the foamy beverage is chilled for consumption. The foamy beverage is then ready for consumption.

As already mentioned, the beverage is shelf-stable at ambient temperatures. An advantage is that the packaged product may be stored at ambient temperatures, in warehouses, in shops or at home by consumers. In shops, a few containers can be stored in refrigerators for on-the-go consumption, so that the consumer can directly prepare a chilled aerated beverage by shaking. At home, consumers can keep the packaged product at ambient temperature and store a few containers in their refrigerator for consumption in the day for instance. This saves room in the refrigerator.

As mentioned, the foamy texture is obtained by shaking the beverage in the closed container, for instance by hand. Shaking by hand may be done by holding the container in the hand, and bending and stretching the arms several times, for instance from 3 to 15 times. Generally, about 5 to 10 movements are sufficient to generate a pleasant foamy texture in the beverage. When preparing the aerated beverage in that manner, the percent of air incorporated of 7 and 20% can be achieved, usually of about 15 to 18%.

The percent of incorporated air is measured as follows: a volume V of the beverage is measured before shaking (Vₒ). The product is shaken 10 times by hand. The volume V of the shaken beverage with air is also measured (V_{f}). The percent of incorporated air (in %) is the result of following equation:

Air incorporated (%)=100*(V_{f0}−V₀)/V₀ (1)
where: V₀=initial volume of beverage (non-aerated beverage)
   V_{f0}=volume of shaken beverage (aerated beverage) at time t=0

### EXAMPLES

### Example 1

Beverage was prepared by mixing 70° C. water, oil and diacetyl tartaric acid ester of mono- and di-glycerides under high agitation. Then blend of sugar with microcrystalline cellulose, carboxymethyl cellulose, carraggenan, gellan gum was added to the above slurry. Further, milk, sodium caseinate, corn starch, sodium chloride, sodium bicarbonate and dipotassium phosphate were added to the tank under agitation. Finally, coffee and other flavour ingredients were added under continuous agitation.

The mixture was then pre-heated to about 75° C., sterilized at 140-143° C. for 3-15 seconds and then flash cooled to 75° C. prior to two step homogenization at 2000/500 psi. The liquid beverage was cooled to about 10° C., and then aseptically filled into 8 oz (about 236 mL) bottles having 30% headspace.

### Example 2

Beverage was prepared by mixing 70° C. water, oil and diacetyl tartaric acid ester of mono- and di-glycerides under high agitation. Then blend of sugar with microcrystalline cellulose, carboxymethyl cellulose, carraggenan, gellan gum was added to the above slurry. Further, milk, sodium caseinate, corn starch, sodium chloride, sodium bicarbonate and dipotassium phosphate were added to the tank under agitation. Finally, coffee and other flavour ingredients were added under continuous agitation.

The mixture was pre-heated to about 60° C., homogenized at 2000/500 psi, filled into 8 oz (about 236 mL) cans having 30% headspace and retorted at 121° C. for 15 min, and cooled to about 35° C.

### Example 3

An aseptic ready to drink foaming beverage was prepared as in Example 1 comprising 1% coffee, 3% milk solids, 1.5% sodium caseinate, 2.5% palm olein oil, 5% of sugar, 2% corn starch, 0.1% diacetyl tartaric acid ester of mono- and di-glycerides, 0.1% sodium bicarbonate, 0.02% dipotassium phosphate, 0.5% blend of microcrystalline cellulose, carboxymethyl cellulose and carrageenan, and 0.035% of high acyl gellan.

Unique indulgent, creamy frothy texture/mouthfeel was obtained after product shaking.

Further, product showed a good shelf life physical stability with no phase separation, gelation, sedimentation or syneresis.

### Example 4

An aseptic ready to drink foaming beverage was prepared as in Example 1 comprising 1% coffee, 6% milk solids, 2.5% palm olein oil, 5% of sugar, 1% corn starch, 0.1% diacetyl tartaric acid ester of mono- and di-glycerides, 0.1% sodium bicarbonate, 0.02% dipotassium phosphate, 0.5% blend of microcrystalline cellulose, carboxymethyl cellulose and carrageenan, and 0.1% of gellan gum.

Unique indulgent, creamy texture/mouthfeel was obtained after product shaking.

Further, product showed a good shelf life physical stability with no phase separation, 3.0 gelation, sedimentation, or syneresis.

### Example 5

A retorted ready to drink foaming beverage was prepared as in Example 2 comprising 1% coffee, 3% milk solids, 2.5% palm olein oil, 1.5% sodium caseinate, 5% of sugar, 2% corn starch, 0.1% diacetyl tartaric acid ester of mono- and di-glycerides, 0.05% sodium bicarbonate, 0.02% dipotassium phosphate, 0.5% blend of microcrystalline cellulose, carboxymethyl cellulose and carrageenan, and 0.1% of gellan gum.

Unique indulgent, creamy texture/mouthfeel was obtained after product shaking.

Further, product showed a good shelf life physical stability with no phase separation, sedimentation or syneresis.

### Example 6

An aseptic ready to drink foaming beverage was prepared as in Example 3 but comprising 0.05% of gellan.

Unique indulgent, creamy texture/mouthfeel was obtained after product shaking, however product showed a gelation after 1 month storage at 4 C.

### Example 7

An aseptic ready to drink foaming beverage was prepared as in Example 3 but comprising 4% starch.

Little aeration was obtained after shaking the beverage. Moreover, gummy texture/mouthfeel was obtained by sensory evaluation.

### Example 8

An aseptic ready to drink foaming beverage was prepared as in Example 3 but without adding starch.

Unstable aeration was obtained after shaking the beverage. Moreover, thinner airy texture/mouthfeel was obtained by sensory evaluation.

### Example 9

An aseptic ready to drink foaming beverage was prepared as in Example 3 but without adding carrageenan.

Thinner texture and less frothy mouthfeel was obtained after shaking the beverage and evaluated by sensory.

### Example 10

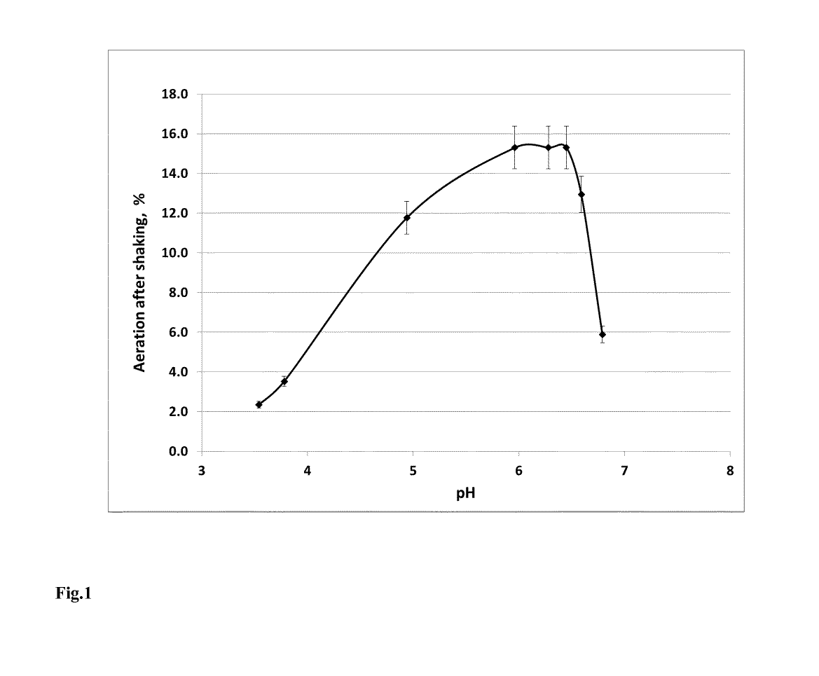

An aseptic ready to drink foaming beverage was prepared as in Example 3 by varying pH. As shown in FIG. 1, the best aeration was observed after shaking the beverage having pH between 5.9 and 6.6.

### Example 11

An aseptic ready to drink foaming beverage was prepared as in Example 10 but having pH of 5.9. Good aeration was found. However, sensory evaluation by a trained panel resulted to an undesirable acidic taste.

### Example 12

A retorted ready to drink foaming beverage was prepared as in Example 5 by varying pH. The best aeration was observed after shaking the beverage having pH between 6.2 and 6.6.

### Example 13

An aseptic ready to drink foaming beverage was prepared as in Example 3 but with addition of 0.25% diacetyl tartaric acid ester of mono- and di-glycerides with HLB value of about 6.

Thinner texture and less frothy mouthfeel was obtained after shaking the beverage and evaluated by sensory.

### Example 14

An aseptic ready to drink foaming beverage was prepared as in Example 3 but with addition of 0.1% diacetyl tartaric acid ester of mono- and di-glycerides but with HLB value of about 16.

No aeration was obtained after shaking the beverage and evaluated by sensory.

### Example 15

An aseptic ready to drink foaming beverage was prepared as in Example 1, but without adding coffee.

Unique indulgent, creamy frothy texture/mouthfeel was obtained after product shaking.

Further, product showed a good shelf life physical stability with no phase separation, gelation, sedimentation or syneresis.

1. An aseptic dairy beverage in a closed container having a headspace of 18 to 35 vol. % of the volume of the container, wherein the beverage comprises:
milk solids ranging from 2 to 6 wt %;
added oil or fat ranging from 1 to 3 wt %;
starch ranging from 1 to 3 wt %;
emulsifier ranging from 0.05 to 0.15 wt %;
gellan ranging from 0.01 to 0.04 wt %;
cellulose ranging from 0.4 to 0.6 wt %;
carrageenan ranging from 0.02 to 0.06 wt % and
the beverage has a pH from 6.2 to 6.6.

2. The beverage of claim 1, wherein the beverage comprises coffee ranging from 0.9 to 1.5 wt %.

3. The beverage of claim 1, wherein the cellulose comprises a blend of carboxymethyl cellulose and microcrystalline cellulose.

4. The beverage of claim 1, wherein the gellan is high-acyl gellan.

5. The beverage of claim 1, wherein the carrageenan is selected from the group consisting of iota, kappa, lambda and combinations thereof.

6. The beverage of claim 1, wherein the starch comprises hydroxypropyl starch.

7. The beverage of claim 1, wherein the emulsifier is selected from the group consisting of monoglycerides, diglycerides, lecithin, lactylates, diacetyl tartaric acid esters of mono-diglycerides, emulsifying starches, and mixtures thereof and the emulsifier have hydrophilic-lipophilic balance (HLB) value ranging from 6 to 8.

8. The beverage of claim 7, wherein the emulsifier is diacetyl tartaric acid esters of mono-diglycerides having HLB value of about 6.

9. The beverage of claim 1, wherein the oil comprises oil having melting point above 25° C.

10. The beverage according to claim 1, wherein the beverage further comprises from 0.03 to 0.1 wt % of a buffering agent, wherein the buffering agent is selected from the group consisting of potassium phosphate, dipotassium phosphate, potassium citrate, potassium bicarbonate, sodium bicarbonate, sodium citrate, sodium phosphate, disodium phosphate and combinations thereof.

11. The beverage according to claim 1, wherein the beverage further comprises flavour ingredient selected from the group consisting of cocoa, tea, caramel, strawberry, banana, vanilla, cinnamon, cardamom, saffron, clove, and mixtures thereof.

12. The beverage according to claim 1, wherein the beverage further comprises a sweetener component.

13. The beverage according to claim 12, wherein the sweetener comprises sugar ranging from 0.5 to 5 wt %.

14. The beverage according to claim 1, wherein the beverage retains an aerated texture for at least 10 minutes after shaking.

15. A process for preparing an aseptic dairy beverage with aerated texture after hand shaking which comprises the step of:
i) providing a packaged product comprising a beverage in a closed container having a headspace of 18 to 35 vol. % of the volume of the container, wherein the beverage comprises: milk solids ranging from 2 to 6 wt %; added oil or fat ranging from 1 to 3 wt %; starch ranging from 1 to 3 wt %; emulsifier ranging from 0.05 to 0.15 wt %; gellan ranging from 0.01 to 0.04 wt %; cellulose ranging from 0.4 to 0.6 wt %; carrageenan ranging from 0.02 to 0.06 wt %; and the beverage has a pH from 6.2 to 6.6; and
ii) shaking the packaged product to obtain the aerated dairy beverage.

16. A process according to claim 15, wherein the shaking is performed by hand.

17. A process according to claim 16, wherein the shaking by hand is performed by shaking the closed container from 3 to 15 times.

18. (canceled)
